(19) United States
(12) Patent Application Publication
(10) Pub. No.: US 2016/0342449 A1
(43) Pub. Date: Nov. 24, 2016

(54) DATA EXCHANGE ACROSS MULTIPLE COMPUTING DEVICES THROUGH A PROACTIVE INTELLIGENT CLIPBOARD

(71) Applicant: Microsoft Technology Licensing, LLC, Redmond, WA (US)

(72) Inventors: Sandy Wong, Seattle, WA (US); Christina Campbell, Redmond, WA (US); Robert L. Rounthwaite, Fall City, WA (US)

(21) Appl. No.: 14/720,720

(22) Filed: May 22, 2015

(51) Int. Cl. G06F 9/54; G06F 7/08; G06F 3/0484; G06F 17/27; H04L 29/08; G06F 3/0482

(52) U.S. Cl. CPC G06F 9/543; H04L 67/1097; G06F 3/0482; G06F 3/04842; G06F 17/2765; G06F 7/08

(57) ABSTRACT

Data exchange across multiple computing devices is provided with a proactive intelligent clipboard that enables users to “cut” or “copy” content from an application program being executed by one computing device and then intelligently and proactively offers such content to the user as part of the user's utilization of another application program being executed by another, different computing device, thereby enabling the user to “paste” such content into such other application program. Content can also be proactively clipped on the user's behalf and can also be offered to other, different users. Analysis is undertaken of content to generate metadata associated therewith. Subsequently, when a user accesses paste functionality, identification can be made, based upon the generated metadata, of previously clipped content that is relevant to the user's current context. Such identified, and previously clipped, content is then proactively presented to the user.

### BACKGROUND

Users of modern computing devices have become accustomed to utilizing multiple different computing devices interchangeably, either to accomplish differing tasks, or in a collaborative fashion to accomplish a single task. For example, a user can see an image while browsing a website on a mobile computing device that subsequently they want to attach in an email while writing an email on a desktop computing device. As another example, a user can have received contact content while utilizing a desktop computing device that the user subsequently wishes to utilize while traveling with a mobile computing device. In such instances, to the extent that the content is available from a centralized location, the user is forced to revisit such a centralized location in order to first download such content to the computing device they are currently utilizing before being able to subsequently utilize such content on that computing device. Thus, for example, the user who had seen an image while browsing websites on a mobile computing device, and who wishes to subsequently attach such an image to an email that the user is now composing on a desktop computing device, would be forced to utilize a web browser on the desktop computing device and again find the image on the website, now utilizing the web browser on the desktop computing device, copy the image therefrom, and then paste the image into the email that the user was composing on the desktop computing device. As another example, the user who had received contact content while utilizing a desktop computing device, in order to utilize such contact content while traveling with their mobile computing device would be forced to first retrieve again such contact content, such as by again logging into their email, copy the contact content from, for example, the email message providing such contact content, and then paste the contact content into whatever application the user was utilizing on their mobile computing device where they had wanted to utilize such contact content in the first place. In some cases, they content is only available on a specific device and must be transferred from one device to another. For example, if a user receives an address in a mobile text message on a smartphone computing device, they must find some way to transfer the data from that smartphone computing device to their desktop computing device.

### SUMMARY

To increase user efficiency and provide data exchange across multiple computing devices a proactive intelligent clipboard can enable users to “cut” or “copy” content from an application program being executed by one computing device and then intelligently and proactively offer such content to the user as part of the user's utilization of another application program being executed by another, different computing device, thereby enabling the user to “paste” such content into such other application program on such other computing device. Additionally, content from one user utilizing one computing device can be made available to one or more different users on other computing devices. When content is added to an operating system clipboard, namely through the user's utilization of cut or copy functionality, an application, or other executing process, can receive a notification to process the clipboard contents and upload them to a central storage service in the cloud. The central storage service can also receive content that was automatically and proactively selected even without the user explicitly clipping such content. Analysis can be undertaken of content to generate metadata associated with such content. Such analysis can include optical character recognition, image analysis and object recognition, alphanumeric format recognition and other like analysis. Subsequently, when a user accesses paste functionality on a computing device, identification can be made, based upon the generated metadata, of content that is relevant to the user's current context. Such identified content can then be proactively presented to the user to increase the user's efficiency in obtaining, and pasting into an application currently being utilized by the user, such content. Such proactive presentation can include the proactive pasting of such content directly into the application currently being utilized by the user, proactively placing such content onto an operating system clipboard of the operating system currently being utilized by the user, or presenting the user with content selection options.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a system diagram of an exemplary system for providing data exchange across multiple computing devices through a proactive intelligent clipboard;

FIG. 2 is a block diagram of an exemplary user interface enabling a user to exchange data across multiple computing devices through a proactive intelligent clipboard;

FIG. 3 is a block diagram of another exemplary user interface enabling a user to exchange data across multiple computing devices through a proactive intelligent clipboard;

FIG. 4 is a flow diagram of an exemplary exchange of data across multiple computing devices through a proactive intelligent clipboard; and

FIG. 5 is a block diagram of an exemplary computing device.

### DETAILED DESCRIPTION

The following description relates to increasing a user's efficiency by facilitating the exchange of data across multiple computing devices through a proactive intelligent clipboard that enables users to “cut” or “copy” content from an application program being executed by one computing device and then intelligently and proactively offer such content to the user as part of the user's utilization of another application program being executed by another, different computing device, thereby enabling the user to “paste” such content into such other application program on such other computing device. Additionally, content from one user utilizing one computing device can be made available to one or more different users on other computing devices. When content is added to an operating system clipboard, namely through the user's utilization of cut or copy functionality, notification can be generated to processes executing on that same computing device, and the content that was added to the operating system clipboard can be obtained by such processes and uploaded to a remote computing device. The remote computing device can also receive content that was automatically and proactively selected even without the user explicitly clipping such content. Analysis can be undertaken of the content to generate metadata associated with such content. Such analysis can include optical character recognition, image analysis and object recognition, alphanumeric format recognition and other like analysis. Subsequently, when a user accesses paste functionality on a computing device, identification can be made, based upon the generated metadata, of the content that is relevant to the user's current context. Such identified content can then be proactively presented to the user to increase the user's efficiency in obtaining, and pasting into an application currently being utilized by the user, such content. Such proactive presentation can include the proactive pasting of such content directly into the application currently being utilized by the user, proactively placing such content onto an operating system clipboard of the operating system currently being utilized by the user, or presenting the user with content selection options.

In addition, in order to facilitate rich collaboration between different users, the originating user may decide to share the content directly with another user. Copied content can be in a complex format that is not normally transferable using existing communication mechanisms like electronic mail, which can only transmit data in the form of text and files. Often applications can have specific internal formats for objects or other content, which cannot be shared with another user without first saving them into a file and transferring the file to another user. Therefore, to facilitate more efficient collaboration, clipboard data can be shared with, or directly sent to, another user, in such a manner that data formats can be preserved, thereby making the same richness available to the other user. If the receiving user has not yet installed a relevant application program, or other process, on their computing device, they can receive a link that can enable the user to view the shared clipboard data through remotely hosted mechanisms and alternatively, or in addition, download the application which will allow them to access the full rich format of the data. As yet another alternative, the user may choose to install computer-executable instructions that can directly populate the local system clipboard with the rich contents. As yet a further alternative, an appropriate application program, or other executing process, such as one having the capability to natively operate on content having a particular data format, can obtain such content directly from the sharing user's remote storage, such as the remote storage that will be described in detail below.

The techniques described herein make reference to “cut”, “copy” and “paste” commands, as well as to “clipped” content. As will be recognized by those skilled in the art, and as utilized herein, the term “cut” means to remove, in response to an explicit user instruction, a selected content portion from the content generated within the context of an application program and place such a selected content portion on an operating system clipboard or other like temporary storage maintained by the operating system, and the term “copy” means to place, in response to an explicit user instruction, a selected content portion, obtained from the content presented within the context of an application program, on an operating system clipboard while simultaneously retaining that selected content as part of the original content that was presented within the context of the application program. The term “clip” means to obtain content, either automatically or in response to an explicit user command, and includes both the “cut” and “copy” actions, as defined above. As will also be recognized by those skilled in the art, and as utilized herein, the term “paste” means to insert content into a context generated by an application program from an operating system clipboard. To clarify, the terms “clip”, “cut”, “copy” and “paste” do not refer to the programmatic data and computer executable-instructions that comprise the application program itself, but rather refer to content taken from or inserted into contexts generated by application programs, such as content generated by a user utilizing an application program, forms generated by application programs through which such application programs can receive user input, and other like contexts generated by application programs. For ease of reference, however, and in accordance with common phrasing utilized by those skilled in the art, reference will be made to content being clipped, such as by being cut or copied, “from” an application program and content being pasted “into” an application program and those of skill in the art will understand that such references refer not to the programmatic executable instructions and data of the application program itself, but rather to the contexts generated by such application programs and with which users interact with such application programs.

Additionally, while the techniques described herein are directed to mechanisms that make use of the ubiquitous operating system clipboard, on which data can be placed utilizing the ubiquitous, and above defined, cut and copy commands, and from which data can be read utilizing the ubiquitous, and above defined, paste commands, they are not meant to suggest a limitation of the described techniques to such specific operating system structures and operating system implemented functionality. To the contrary, the described techniques are equally utilizable with any data sharing paradigm supportive of the mechanisms and functionality described below.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

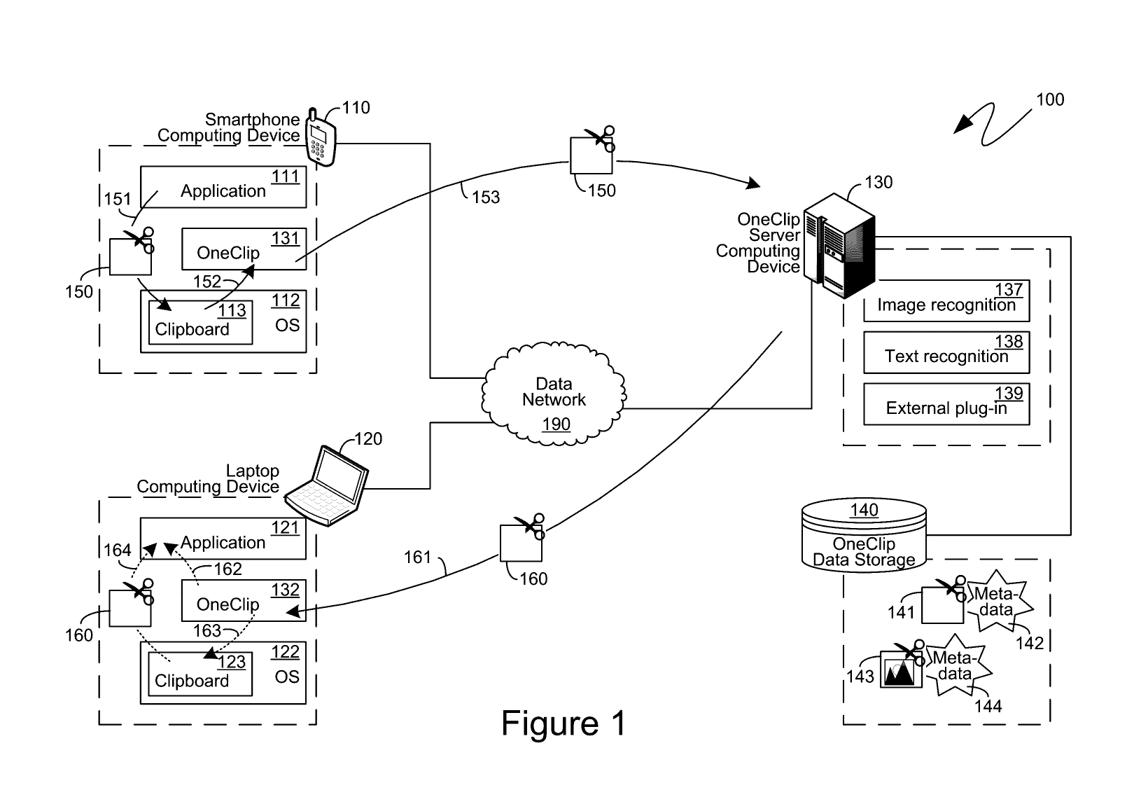

With reference to FIG. 1, an exemplary system 100 is illustrated, providing context for the descriptions below. The exemplary system 100 of FIG. 1 is shown as comprising multiple client computing devices, namely a smartphone computing device 110 and a laptop computing device 120 that are both communicationally coupled to a network 190. The network 190 also has, communicationally coupled to it, a centralized and network accessible computing device represented by the server computing device 130. Communicationally coupled to the exemplary server computing device 130 can be a database or other like data storage functionality, such as exemplary data storage 140.

The exemplary system 100 of FIG. 1 illustrates one exemplary operation of a proactive and intelligent clipboard that facilitates the exchange of data across multiple computing devices. By way of example, a user utilizing the smartphone computing device 110 can clip some content 150, as illustrated by the clip action 151, which can result in the data being taken from the context of an application, such as exemplary application 111 that is executing on the computing device 110, and being stored within a clipboard, such as exemplary clipboard 113, or other like temporary storage area of an operating system, such as exemplary operating system 112 which is also executing on the computing device 110. According to one aspect, mechanisms associated with the proactive and intelligent clipboard can include computer-executable instructions that can execute on the computing device 110 and which can receive notification, such as from the exemplary operating system 112, when new content is added to the clipboard 113. For ease of reference, the term “OneClip” will be utilized as shorthand within the drawings for mechanisms associated with the proactive and intelligent clipboard being described herein. Thus, the exemplary computing device 110 can include, as executing on it, a proactive and intelligent clipboard process, such as the exemplary process 131, which can receive a notification, such as from the exemplary operating system 112, that the content 150 was added to the clipboard 113.

In response to such notification, the process 131 can obtain the content 150, from the clipboard 113, as illustrated by the operation 152, and can transmit the content 150 to a remote computing device. Within the specific exemplary system 100 shown in FIG. 1, the process 131, executing on the exemplary client computing device 110 can obtain the content 150 that the user had clipped from the application 111, also executing on the exemplary client computing device 100, and can upload, as illustrated by the upload action 153, such content 150 to the exemplary server computing device 130.

Alternatively, or in addition, content can be clipped without an explicit user action, such as an explicit user cut or copy action. More specifically, processes executing on a computing device, such as the exemplary process 131 executing on the smart phone computing device 110, in addition to being informed of content placed an operating system clipboard, such as the exemplary clipboard 113, can also monitor content that the user is exposed to, such as through an application context generated by, for example, the application 111, or which the user enters into an application context, again, such as the application context generated by the application 111. The monitoring process, such as, for example, the exemplary process 131, can automatically and proactively clip specific ones of such detected content. For example, the application 111 can be a ubiquitous web browser application program and the individual webpage addresses visited by a user in utilizing such an exemplary application 111 can be automatically and proactively clipped, such as by the exemplary process 131, without the user issuing an explicit cut or copy command. As another example, information entered by the user into the context generated by the application 111 can, likewise, be automatically and proactively clipped. For example, the application 111 can be an email application program and email addresses entered or selected by the user can be automatically in proactively clipped, such as by the exemplary process 131.

According to one aspect, content that is automatically in proactively clipped can be of predefined categories such as, for example, web or network addresses, email addresses, telephone numbers, contact names, geographic addresses, photographs taken with a computing device, or recently imported onto a computing device, and other like predefined categories of information. In such an aspect, any content falling into such categories can be automatically and proactively clipped. Alternatively, or in addition, the automatic and proactive clipping of content can be informed by content the user previously cut or copied. For example, if the user recently copied a network address, then other detected network addresses can, likewise, be proactively clipped. As another example, if the user recently copied a tracking number, such as provided by a shipping company, then other tracking numbers detected within the same application context, or within different application contexts, can, likewise, be proactively clipped. Like user cut or copied content, proactively clipped content can be transmitted, from the user's computing device from which it was proactively clipped, to a centralized service, such as that implemented by the exemplary server computing device 130.

Content received by the exemplary server computing device 130, such as the exemplary content 150, can be analyzed to derive metadata associated with such content. Consequently, the exemplary server computing device 130 is illustrated as comprising and executing various processes that perform various forms of analysis on content. For example, the image recognition component 137 can comprise computer executable instructions which, when executed by the exemplary server computing device 130, can perform image analysis on the content 150, if the content 150 is an image. Such image analysis can include, for example, optical character recognition that can convert, into text, an image comprising textual characters in a manner well known to those skilled in the art. As a specific example, if the content 150 was an image of the wall of the Lincoln Memorial containing the Gettysburg address, then included among the metadata generated for such an image can be the text of the Gettysburg address in computer-readable textual format as would have been generated by optical character recognition processing being applied to such an image.

The image analysis performed by the exemplary image recognition component 137 can also comprise, for example, facial recognition. As will be recognized by those skilled in the art, facial recognition image analysis can identify persons pictured in images based upon known facial aspects, or facial images, of such persons. Thus, as a specific example, if the content 150 was an image of Albert Einstein, then included among the metadata generated for such an image can be computer-readable content indicating that the content 150 was determined to be an image of Albert Einstein.

Analogous to the functionality of the image analysis component 137 can be text recognition performed by a text recognition component, such as the exemplary text recognition component 138. The text recognition component 138 can recognize formats and patterns of textual content to identify and distinguish between various different types of textual content. For example, the text recognition component 138 can recognize text beginning with “http:// . . . ” or “www . . . ” as being web addresses. As another example, the text recognition component 138 can recognize text having an “@” symbol and ending with a common domain identifier, such as “.edu” or “.com” as being an email address. As yet another example, the text recognition component 138 can recognize text of ten numeric digits, interspersed in groups of three, three and four as being a telephone number. Such computer-readable identification and categorization generated by the text recognition component 138 can also be part of any metadata generated for, and subsequently associated with, the content 150.

According to one aspect, the processes executing on a server computing device, such as exemplary server computing device 130, can include processes provided by external sources, or otherwise providing extensibility as to the nature and type of the content that can be recognized. Consequently, in the exemplary system 100 of FIG. 1, the exemplary server computing device 130 can comprise an external plug-in 139 that can analyze the content 150 in accordance with predefined formats, types, and other like computer-understandable aspects in order to detect specific content. For example, the external plug-in 139 can be provided by a shipping company and can comprise functionality that can analyze an image or textual content to identify tracking numbers of such a shipping company in accordance with the format utilized by such a shipping company to generate its tracking numbers. For example, if a shipping company's tracking numbers are always in the format of four numeric characters, followed by four alphabetic characters, followed by five numeric characters, then the exemplary external plug-in 139 can, if the content 150 is textual content, search such textual content for such a combination of numeric and alphabetic characters. Conversely, continuing the present example, if the content 150 is an image, then the exemplary external plug-in 139 can analyze such an image to detect, for example, a barcode comprising such tracking content in accordance with a barcode format utilized by such a shipping company.

Optionally, or in addition, the various content analysis processes executing on, for example, the exemplary server computing device 130, can operate in a cooperative manner, such that the output of one process is utilized as the input to another. For example, if the content 150 is an image, then the image recognition component 137 can process such an image and can, as described above, detect text within such an image and convert such into computer-readable text, such as through optical character recognition mechanisms. Such computer-readable text, output by the image recognition component 137, can then serve as an input to the text recognition component 138, thereby enabling the text recognition component 138 to recognize the text as, for example, an email address, telephone number, or other like data structure. In such a manner, for example, an image of a business card can be associated with metadata that includes the textual content of such a business card, as well as type content identifying specific subsets of such textual content as, for example, an email address, telephone number, website address, a geographic address, and other like types.

Upon processing the received content 150, and generating metadata associated therewith, the content 150 can be stored in a data storage together with such metadata, such as, for example, the exemplary data storage 140. For purposes of illustration, the exemplary data storage 140 is shown in FIG. 1 is comprising content 141, associated with metadata 142, and content 143, associated with metadata 144. According to one aspect, the exemplary data storage 140 can be delineated in accordance with a particular user such that the content cut or copied by that particular user, or the content proactively clipped on behalf of that particular user, while utilizing any computing device, or a defined subset of computing devices, can be stored in the exemplary data storage 140 and linked with such a specific user.

In addition to the metadata generated by the exemplary server computing device 130, other metadata that can be associated with content stored in the exemplary data storage 140 can include metadata received with the content 150, such as could have been collected by the process 131, for example. Such metadata can include content such as when the content 150 was cut or copied, the context from which such content was cut or copied, such as, for example, the application 111, the content being displayed by the application 111, the actions of the user in interacting with the application 111 immediately preceding the user's cutting or copying of the content 150, and other like contextual content.

Subsequently, when the same user that had copied the content 150 on the exemplary smartphone computing device 110 utilizes a different computing device, such as, for example, the exemplary laptop computing device 120, the user can have available to them the content 150, and other content that that same user can have cut or copied while utilizing computing devices such as, for example, the exemplary smartphone computing device 110, the exemplary laptop computing device 120, or other computing devices utilized by such a user. For example, the same user that had copied the content 150, while interacting with the application 111 via the exemplary smartphone computing device 110, can now be interacting with an application, such as exemplary application 121, through the exemplary laptop computing device 120 on which such an exemplary application 121 is executing. Such a user can desire to paste into the application context created by the application 121 content that the user had previously copied.

According to one aspect, processes executing on the exemplary laptop computing device, such as the exemplary proactive intelligent clipboard process 132, can detect user action directed to paste functionality, or other user action indicative of the user desiring to enter content that is available from the exemplary data storage 140, and can intelligently and proactively provide such content to the user. More specifically, the exemplary process 132 can communicate with processes executing on a remote computing device, such as, for example, the exemplary server computing device 130, to intelligently identify, such as based on the above-described metadata, which content, from the data storage 140, the user might desire. For example, the process 132 can obtain a context of the user action and can provide such a context to the server computing device 130. The context of the user action can include content regarding the application 121 and the application context that was generated by the application 121 and with which the user is interacting. For example, if the application is a content creation application, the relevant context can include previously pasted-in content, content that the user most recently generated utilizing the application, and other like context. As another example, if the application context created by the application 121 comprises forms or entry fields into which the user can enter content, the relevant context can include the format of content acceptable by those forms or fields, surrounding content that can be indicative of the sort of content to be entered into those forms or fields, and other like contextual content.

As way of a specific example, if the application 121 is a word processing application, and the user is generating a word processing document utilizing such an application, the relevant context can include any previously pasted-in content by the user. For example, if the user had copied, in succession, three different photographs, such as via the application 111 executing on the computing device 110, and had then pasted two of those photographs into the word processing document being generated by the application 121 executing on the computing device 120, the pasting-in of those two photographs can be relevant context that can enable processes executing, either on the computing device 120, on the server computing device 130, or combinations thereof, to identify that the third photograph is most likely the next content that the user will seek to paste into the document. More specifically, each of the three photographs that the user had copied utilizing the application 111, for example, can have been stored in the data storage 140 with metadata indicative of the fact that the three photographs had been copied in close temporal succession, or “one after the other”. Consequently, when context detected by the process 132 is indicative of two of those photographs being pasted-in, then utilizing such metadata, and such context, a determination can be made that the third photograph is most likely to be the next item that the user will seek to paste into, for example, the word processing document created utilizing the exemplary application 121.

As another specific example, if the application 121 is a web browser, and the user has utilized the web browser to browse to a webpage into which the user can enter a tracking number for a specific shipping company, the relevant context can include the web domain, or other identifier of such a webpage, and the fact that the user has directed input into a form which is programmatically designed to accept tracking numbers. Utilizing such contextual content, the data storage 140 can be searched for metadata that indicates that the content associated with such metadata is a tracking number of such a shipping company. According to one aspect, if there is only one such tracking number is associated with that specific user in the data storage 140 then that tracking number can be automatically, and proactively, entered into the web form on behalf of the user. Thus, from the perspective of the user, the user can obtain such a tracking number utilizing, for example, the application 111 executing on the computing device 110, can copy such a tracking number, and can then subsequently utilize the application 121, executing on the computing device 120, to visit such a shipping company's website, and, upon clicking into the portion of the webpage that provides for entry of tracking numbers, the user can have the tracking number that they previously copied, from a different computing device, automatically, and proactively, entered for them. In such a manner, a user's efficiency can be increased.

Proactive entry of previously cut or copied content is only one mechanism by which data can be exchanged across multiple computing devices through a proactive intelligent clipboard. More specifically, and with reference to exemplary system 100 of FIG. 1, the provision of contextual content, such as from the exemplary process 132, can enable processes executing on the computing device 120, the server computing device 130, or combinations thereof, to identify one or more previously cut or copied content items associated with the user in the data storage 140 based upon the metadata corresponding to such identified previously cut or copied content items. Once one or more relevant content items, such as exemplary content 160, are identified, they can be provided, such as from the exemplary server computing device 130, to the process 132 executing on the exemplary computing device 120, as illustrated by the exemplary communication 161. Subsequently, the exemplary process 132, executing on the exemplary computing device 120, can, according to one aspect, directly provide content 160 to the application 121, as illustrated by the action 162. In such an aspect, the provision of the content 160 can be analogous to a paste command, except that such content can be provided directly from the exemplary process 132 and can be provided either proactively, or in response to explicit user action. For example, the user can be presented with a menu, or other like selection mechanism, for which the user can select from among multiple content items, each of which was intelligently selected based upon the determined context and the metadata associated with such previously cut or copied content items. User selection, through such a selection mechanism, can then cause the exemplary process 132 to provide such content directly to the application context generated by the application 121, as illustrated by the action 162.

According to another aspect, content received by the exemplary process 132 can be provided, instead, to a clipboard 123 of an operating system 122 that is executing on the exemplary computing device 120, as illustrated by the action 163. The user can then paste the content 160 into the application 121, as illustrated by the action 164. The provision, by the exemplary process 132, of the content 160 to the clipboard 123, as illustrated by the action 163, can be proactive or can be in response to explicit user action, such as an explicit user selection received through a user selection mechanism. For example, if only one content item was identified as being relevant, given the context of the user's interaction with the application 121 and the metadata associated with content items in the data storage 140 that are associated with the user, then the process 132 can proactively place such an identified content item, such as, for example, the exemplary content 160, onto the clipboard 123. In such an instance, a user interacting with the application 121 need only direct action to an appropriate portion of the application context generated by the application 121 and then select the paste command and the content that the user most likely desired to paste into such an application would have been proactively placed on the clipboard 123 such that, when the user executes such a paste command, that content is pasted into the application. Conversely, if multiple content items are identified as potentially being relevant, based on the context of the user's interaction with the application 121 and the metadata associated with such content items, then the user can be provided with mechanisms by which the user can select specific one of such content items such as, for example, the aforementioned menu. An explicit user selection of a specific one of such content items can then trigger the process 132 to display such a content item, such as the exemplary content 160, onto the clipboard 123. The user can then, subsequently, paste such content 160 into the application 121 through another explicit user action, namely the triggering of the paste command, represented by the action 164.

While the above descriptions have been provided within the context of a single user cutting or copying content while utilizing one computing device and then pasting it while utilizing another, different computing device, the above described mechanisms can equally enable one user, utilizing one computing device, to cut or copy content while utilizing that one computing device and then directly provide such content to another, different user, utilizing a different computing device, thereby enabling that other, different user to paste such content while utilizing such a different computing device. For example, referencing again FIG. 1, a user utilizing the smartphone computing device 110 can identify another user to whom the user utilizing smartphone computing device 110 seeks to directly provide the content 150 that the user had cut or copied to the clipboard 113. Subsequently, according to such an aspect, the content 150, as stored in the data storage 140, can be associated, not only with an identification of the user utilizing the smartphone computing device 110, but also with an identification of the user to whom such content 150 was to be provided. Such other user can, for example, be utilizing the laptop computing device 120, and, when communicating with the server computing device 130, can have access to content, both that that user themselves clipped, as well as content to which that user has been provided access, such as the aforementioned exemplary content 150. Consequently, when such a subsequent user, utilizing the laptop computing device 120, seeks to paste content into an application, such as exemplary application and hundred and 20, such user can have access to the content 150 to which a different user had provided them access.

As indicated previously, if the application 111, executing on the smartphone computing device 110, from which the content 150 was originally clipped, and the application 121, executing on the laptop computing device 120, into which such exemplary content 150 could be pasted, are both the same application, or are both applications that natively except the same types of content, then the exemplary content 150 can be passed from one user, utilizing one computing device, to a different user, utilizing a different computing device, without loss of data and with the content retaining all of its original attributes and capabilities. In such a manner “rich” content, or content whose attributes or capabilities are beyond those traditionally accommodated through content delivery mechanisms, can be exchanged without negatively impacting the “richness” of such content.

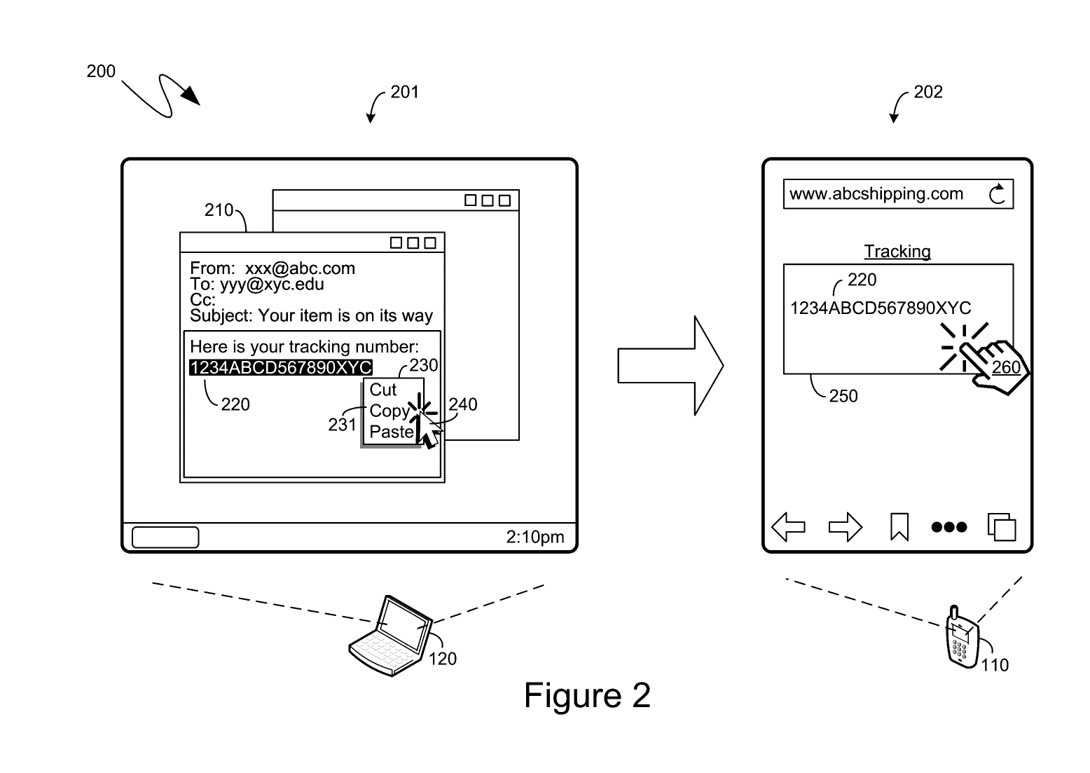

Turning to FIG. 2, the system 200 shown therein illustrates an exemplary sequence of user interfaces that provide examples of how users can access and interact with the above described functionality. For example, exemplary user interface 201, shown in FIG. 2, can represent a user interface such as would be presented by a desktop or laptop computing device, such as the exemplary laptop computing device 120. Within the exemplary user interface 201, a window 210 is shown comprising, for example, an email interface. A specific email message being presented within exemplary window 210 can include, for example, a tracking number 220. For purposes of illustration, such a tracking number can be of use to the user and, consequently, the user can copy such a tracking number utilizing existing operating system copy commands. For example, the user can direct input to the email application presenting the exemplary window 210 that can cause the application to present a contextual menu, such as the exemplary contextual menu 230, that can comprise a copy command 231. User input 240 directed to such a copy command 231 can copy the tracking number 220 in a manner well known to those skilled in the art.

As detailed above, according to one aspect, the copying of the tracking number 220, from within the context of the email program illustrated in the exemplary user interface 201, can cause the tracking number 220 to be placed in an operating system clipboard of an operating system executing on the exemplary laptop computing device 120 that is presenting the exemplary user interface 201. Additionally, the placing of content on the operating system clipboard can notify a process, such as that described above, and such a process can upload the copied tracking number 220 to a centralized repository, such as the above described server computing device and data storage. As part of the storage of the tracking number 220 in such a data storage, metadata associated with the tracking number 220, such as, for example, identification of the alphanumeric characters of the tracking number 220 as being a tracking number, can be also stored in the data storage and associated with the tracking number 220.

Subsequently, when the same user utilizes a different computing device such as, for example, the smartphone computing device 110, the user can interact with a web browser application program on such a smartphone computing device 110, generating a user interface analogous to the exemplary user interface 202, shown in FIG. 2. According to one aspect, when the user directs input, such as exemplary user touch input 260, to a field 250, presented as part of a webpage, as shown in the exemplary user interface 202, a determination can be made as to whether any content that the user has previously cut or copied is relevant to the user's current context. In the present example, the user's context can include the fact that the user is visiting a webpage of a specific shipping company, as illustrated by the exemplary user interface 202, and has directed user input to a field 250 that is programmatically constructed to receive tracking numbers. Such context can be compared with metadata associated with previously copied content and can identify the previously copied tracking number 220 as being a tracking number of that specific shipping company. Consequently, the exemplary user touch input 260 can trigger the above-described processes to automatically insert the tracking number 220. In such a manner, a user can copy content on one computing device, such as exemplary laptop computing device 120, and can have such content available for pasting into an application program executing on another, different computing device, such as exemplary smartphone computing device 110. The user is, thereby, saved from having to again access their email, on the exemplary smartphone computing device 110, access the tracking number 220 from their email, and then paste it into the field 250. Instead, the user was able to achieve greater efficiency as simply directly visiting the website, on the smart phone computing device 110, and then having the tracking number 220 automatically available to them.

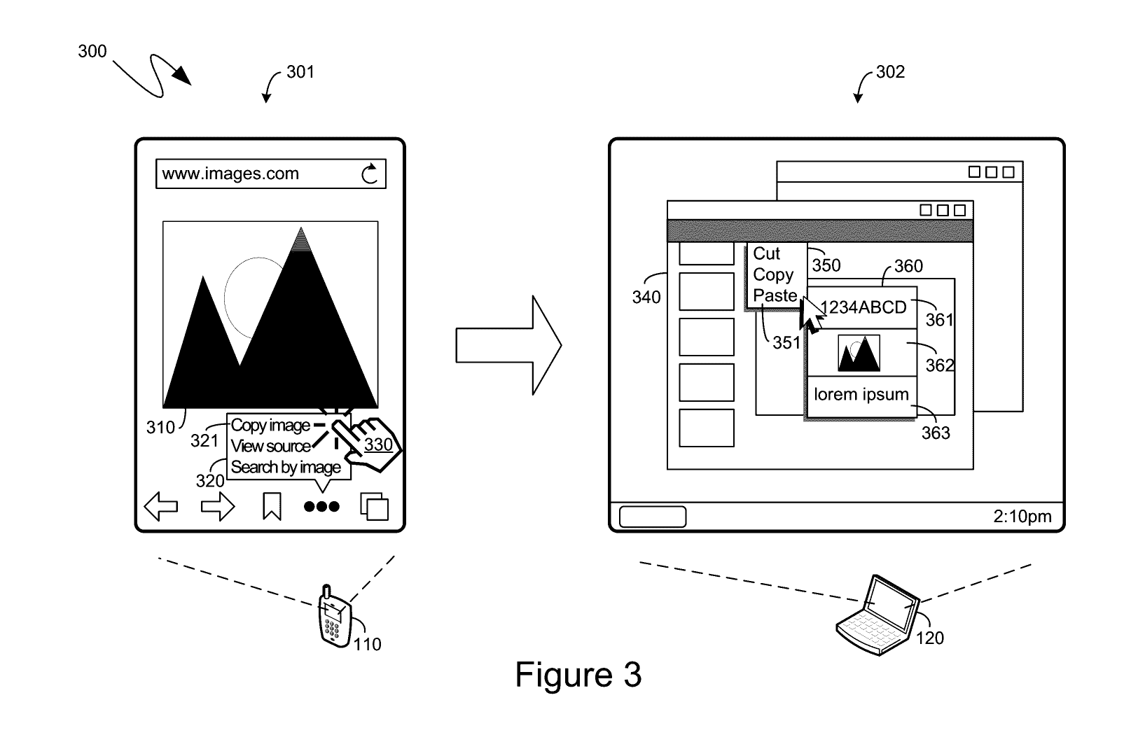

Turning to FIG. 3, the exemplary system 300 shown therein illustrates another exemplary sequence of user interfaces that provide another example of how users can access and interact with the above described functionality. For example, the exemplary user interface 301 can be provided by a web browser application program, or other like application program executing on the smartphone computing device 110. As shown by the exemplary user interface 301, the user can have utilized a web browser application program to find an image 310 that the user desires to copy. Such a copy can be made by, for example, user input, such as exemplary user touch input 330, being directed to a copy image command 321 presented by an exemplary contextual menu 320. As will be recognized by those skilled in the art, utilization of such a ubiquitous copy command can result in the image 310 being placed on an operating system clipboard of an operating system executing on the exemplary smartphone computing device 110. As before, the placing of content on an operating system clipboard can notify the above-described processes, which can execute to obtain such content from the operating system clipboard and upload it to a centralized location, such as the above described server computing device and content data storage. Additionally, such content can have metadata generated for it and associated with it within the content data storage.

By way of continuing the present, illustrated example, at a subsequent time a user can be utilizing a different computing device such as, for example, the exemplary laptop computing device 120, and can be interacting with content creation application program, such as the presentation application program illustrated in the exemplary user interface 302. The user can be interacting with the presentation application program, to, for example, create a slide deck, as illustrated in the window 340, and can recall that the user copied an image, namely the image 310, while utilizing a different computing device, namely exemplary computing device 110, at a prior point in time. The user can then direct action that can be indicative of a desire to paste content into the application, namely as part of the slide deck being created in the window 340. According to one aspect, such action can be directed within the context of the application program itself. Alternatively, or in addition, user action can be directed to a separately executing component, such as a component of the above described proactive intelligent clipboard. As will be recognized by those skilled in the art, such a component can execute in the background and can provide various mechanisms by which the user can direct input to it including, for example, menu bar icons, hotkey commands, contextual menus, and other like input mechanisms.

For purposes of illustration, the exemplary user interface 302 illustrates an integration between existing application programs and proactive and intelligent clipboard functionality. Thus, for example, the user can trigger a menu 350 comprising the paste command 351 and, in response to user action directed to the paste command 351, a subsequent menu 360 can be presented. As indicated previously, however, the exemplary menu 360 can also be presented in response to user action directed directly to a proactive and intelligent clipboard component. In the present, illustrated example, the user context, namely the user's interaction with the exemplary presentation application program, as illustrated in exemplary user interface 302, can result in multiple content items being identified as potentially relevant to such a user context, based upon the metadata associated with such content items. Consequently, the exemplary menu 360 can provide the user with an opportunity to select a specific one of those content items, each of which can have been previously copied by the user, whether from application programs executing on the same computing device the user is currently utilizing, such as, for example the laptop computing device 120, or from application programs executing on different computing devices that the user previously utilized such as, for example, the exemplary smartphone computing device 110. Thus, for example, item 362 of the exemplary menu 360 can be the image 310 that the user previously copied while utilizing an application executing on the smartphone computing device 110. User selection of any one of the items presented by the exemplary menu 360, such as the exemplary tracking number 361, the exemplary image 362, or the exemplary text 363 can result in such a content item either being directly pasted into the application program the user is currently utilizing such as, for example, being pasted directly into the slide deck the user is currently generating utilizing the presentation application program exemplarily illustrated by the user interface 302, or can result in such a selected content item being placed onto the operating system clipboard of the operating system executing on the computing device the user is currently utilizing, namely the exemplary computing device 120, for the user to subsequently paste when they so desire. In such a manner, user efficiency can be increased by providing the user with access to previously copied content items irrespective of the computing device from which such content items were previously cut or copied, and providing such previously cut or copied content items in a proactive and intelligent manner.

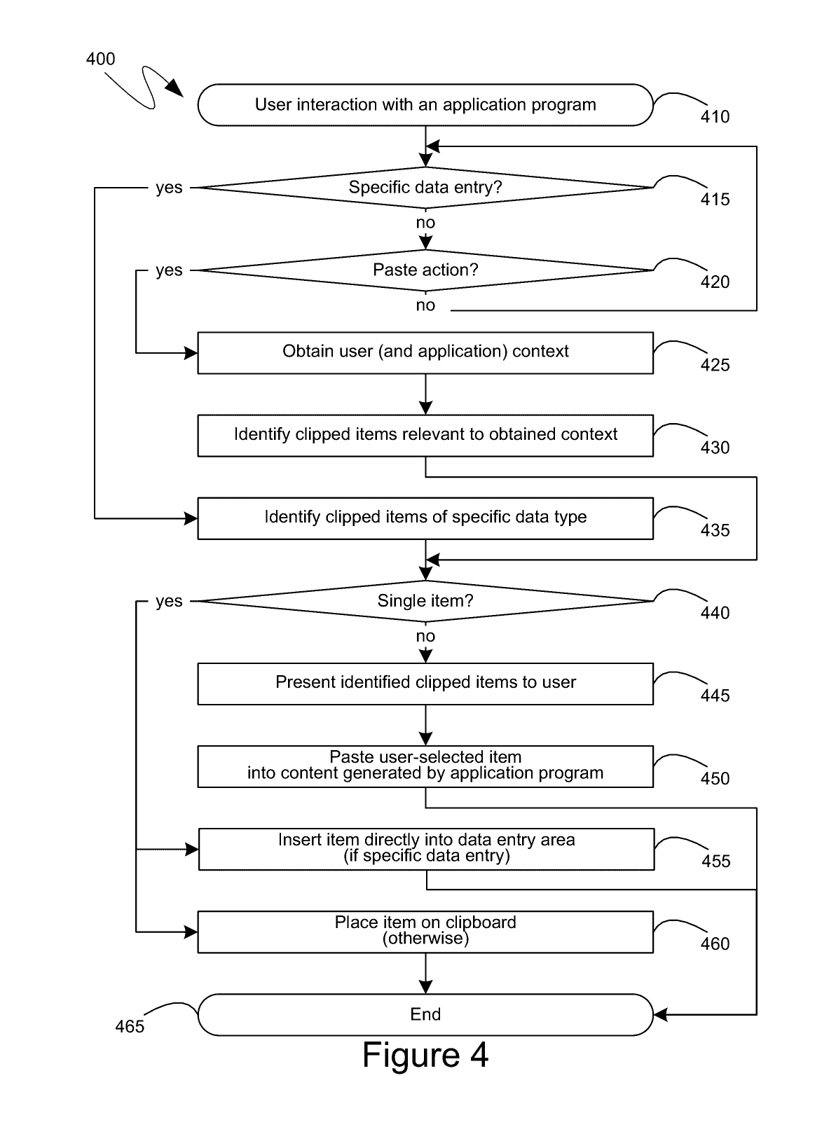

Turning to FIG. 4, the exemplary flow diagram 400 shown therein illustrates an exemplary series of steps that can be performed in proactively and intelligently presenting previously cut or copy content items, irrespective of the computing device from which such content items were previously cut or copied. Initially, as illustrated in FIG. 4, at step 410, a user can be interacting with an application program. According to one aspect, at step 415, an initial determination can be made as to whether the user's interaction with the application program is indicative of the user desiring to enter data into an input mechanism, such as a form, field, or other like input mechanism, that is programmatically constructed to receive a specific type of data, or is otherwise contextually focused on a specific type of data, such as, for example, telephone numbers, email addresses, tracking numbers and other like specific data types and formats. If, at step 415, it is determined that the user's interaction with the application program is directed to such a input mechanism that is to receive a specific type of data, then processing can proceed to step 435 and previously clipped content items, namely content items that were previously cut or copied, that are of that specific data type and format can be identified. Processing can then proceed to step 440, where determination can be made as to whether multiple of such items were identified. If only one such item was identified, then processing can proceed to step 455 and such a content item can be directly and proactively inserted into the input mechanism that is directed to such a specific type of data. The relevant processing can then end at step 465.

Conversely, if, at step 440, it is determined that multiple previously clipped items were identified as being of the specific type and format delineated by the input mechanism of the application program with which the user is interacting, then processing can proceed to step 445 where such multiple clipped items, that were identified based upon the metadata associated with them and the user's context and interacting with the application program, can be presented to the user. As indicated previously, the presentation of such multiple identified clipped items, at step 445, can be integrated into the application program with which the user is currently interacting, or can be presented by a dedicated intelligent and proactive clipboard component executing separately from such an application program. In response to the presentation, at step 445, of such multiple content items, the user can select one such content item, and, at step 450, such a user-selected item can be pasted into the application program. As indicated previously, a user selected item can either be directly pasted into the application program, or it can be placed on an operating system clipboard for subsequent pasting at the user's discretion. The relevant processing and then end at step 465.

Returning back to step 415, if the user's interaction with the application program does not entail user input directed to an input mechanism directed to a specific type and format of data, processing can proceed to step 420 where subsequent determination can be made as to whether the user has provided input indicative of a paste action or other like input indicative of the users desire to insert previously clipped content. If, at step 420, it is determined that the user has not yet provided such input in their interaction with the application program, processing can loop back to step 415. Conversely, if, at step 420, it is determined that the user has provided input indicative of their desire to insert previously clipped content, then processing can proceed to step 425 and the context within which such user input was detected can be obtained and, at step 430, previously clipped items relevant to such context can be determined based upon the metadata associated with such previously clipped content items, such as in the manner described in detail above. Processing can then proceed with step 440 which, as described above, can determine whether only a single such content item was identified at step 430. If, at step 440, only a single item was identified, then, according to one aspect, such an item can be proactively placed on the clipboard, as illustrated at step 460. Such previously clipped content can then be proactively available to the user to paste into the application program when the user desires to do so. The relevant processing can then end at step 465.

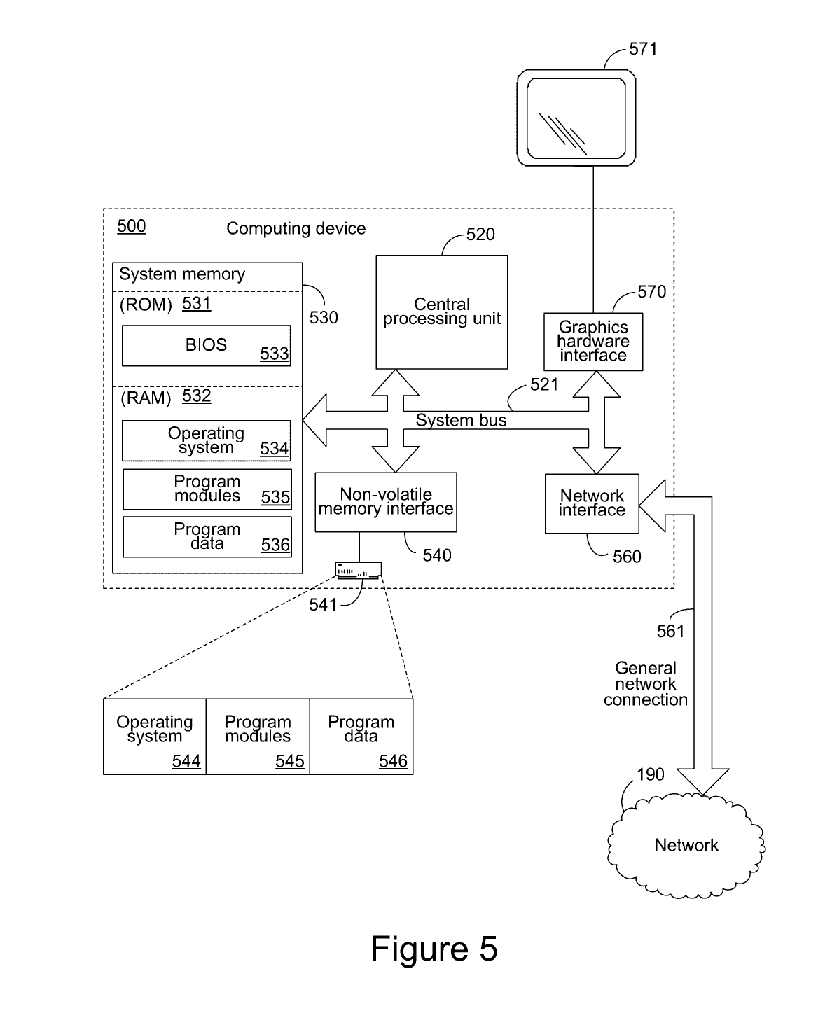

Turning to FIG. 5, an exemplary computing device 500 is illustrated which can perform some or all of the mechanisms and actions described above. The exemplary computing device 500 can include, but is not limited to, one or more central processing units (CPUs) 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. The computing device 500 can optionally include graphics hardware, including, but not limited to, a graphics hardware interface 570 and a display device 571, which can include display devices capable of receiving touch-based user input, such as a touch-sensitive, or multi-touch capable, display device. Depending on the specific physical implementation, one or more of the CPUs 520, the system memory 530 and other components of the computing device 500 can be physically co-located, such as on a single chip. In such a case, some or all of the system bus 521 can be nothing more than silicon pathways within a single chip structure and its illustration in FIG. 5 can be nothing more than notational convenience for the purpose of illustration.

The computing device 500 also typically includes computer readable media, which can include any available media that can be accessed by computing device 500 and includes both volatile and nonvolatile media and removable and non-removable media. By way of example, and not limitation, computer readable media may comprise computer storage media and communication media. Computer storage media includes media implemented in any method or technology for storage of content such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired content and which can be accessed by the computing device 500. Computer storage media, however, does not include communication media. Communication media typically embodies computer readable instructions, data structures, program modules or other data in a modulated data signal such as a carrier wave or other transport mechanism and includes any content delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer content between elements within computing device 500, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, other program modules 535, and program data 536.

The computing device 500 may also include other removable/non-removable, volatile/nonvolatile computer storage media. By way of example only, FIG. 5 illustrates a hard disk drive 541 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and other computer storage media as defined and delineated above. The hard disk drive 541 is typically connected to the system bus 521 through a non-volatile memory interface such as interface 540.

The drives and their associated computer storage media discussed above and illustrated in FIG. 5, provide storage of computer readable instructions, data structures, program modules and other data for the computing device 500. In FIG. 5, for example, hard disk drive 541 is illustrated as storing operating system 544, other program modules 545, and program data 546. Note that these components can either be the same as or different from operating system 534, other program modules 535 and program data 536. Operating system 544, other program modules 545 and program data 546 are given different numbers hereto illustrate that, at a minimum, they are different copies.

The computing device 500 may operate in a networked environment using logical connections to one or more remote computers. The computing device 500 is illustrated as being connected to the general network connection 561 through a network interface or adapter 560, which is, in turn, connected to the system bus 521. In a networked environment, program modules depicted relative to the computing device 500, or portions or peripherals thereof, may be stored in the memory of one or more other computing devices that are communicatively coupled to the computing device 500 through the general network connection 561. It will be appreciated that the network connections shown are exemplary and other means of establishing a communications link between computing devices may be used.

Although described as a single physical device, the exemplary computing device 500 can be a virtual computing device, in which case the functionality of the above-described physical components, such as the CPU 520, the system memory 530, the network interface 560, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where the exemplary computing device 500 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executed within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

The descriptions above include, as a first example, a computing device comprising: one or more processing units; a network interface; and one or more computer-readable media comprising computer-executable instructions which, when executed by the one or more processing units, cause the computing device to: detect addition of a new content item to an operating system clipboard through a user-initiated cut or copy command; upload, through the network interface, the new content item to a remote clipped content data storage; detect a user action on the computing device indicative of an entry of content into an application program executing on the computing device; determine a context of the detected user action; identify one or more potentially relevant content items from the remote clipped content data storage based on the determined context and metadata associated with content items in the remote clipped content data storage; and proactively provide at least some of the potentially relevant content items to be entered into the application program in furtherance of the detected user action.

A second example is the computing device of the first example, wherein the computer-executable instructions for proactively providing at least some of the potentially relevant content items comprise computer-executable instructions, which, when executed by the one or more processing units cause the computing device to generate a user selection mechanism presenting, for selection by the user, at least some of the potentially relevant content items.

A third example is the computing device of the second example, wherein the computer-executable instructions for proactively providing at least some of the potentially relevant content items comprise computer-executable instructions, which, when executed by the one or more processing units cause the computing device to place, onto the operating system clipboard a user selected one of the potentially relevant content items.

A fourth example is the computing device of the first example, wherein the computer-executable instructions for proactively providing at least some of the potentially relevant content items comprise computer-executable instructions, which, when executed by the one or more processing units cause the computing device to proactively enter, directly in response to the detected user action, a single potentially relevant content item into an input mechanism presented by the application program, the input mechanism configured to accept a specific type of data, the single potentially relevant content item being an only content item, from among the potentially relevant content items, having the specific type of data that the input mechanism is configured to accept.

A fifth example is the computing device of the first example, wherein the potentially relevant content items were clipped from one or more application programs executing on one or more other computing devices differing from the computing device.

A sixth example is the computing device of the first example, wherein the determined context comprises content pasted by the user into the application preceding the detected user action.

A seventh example is the computing device of the first example, wherein the one or more computer-readable media comprise further computer executable instructions, which, when executed by the one or more processing units, cause the computing device to: proactively clip another content item that was either entered by the user or presented to the user; and upload, through the network interface, the other content item to the remote clipped content data storage.

An eighth example is the computing device of the seventh example, wherein the proactive clipping of the other content item is triggered by the other content item being of a predefined type.

A ninth example is the computing device of the first example, wherein the identified one or more potentially relevant content items comprise content items clipped by a different user.

A tenth example is a computing device comprising: one or more processing units; a network interface; and one or more computer-readable media comprising computer-executable instructions which, when executed by the one or more processing units, cause the computing device to: receive, through the network interface, from a first client computing device, an uploaded content item and an identification of a user with whom the uploaded content item is associated; generate metadata associated with the uploaded content item by performing at least one of image recognition or text recognition on the uploaded content item; store the uploaded content item into a remote clipped content data storage; associate, within the remote clipped content data storage, the uploaded content item with the generated metadata and the identified user; receive, through the network interface, from a second client computing device differing from the first client computing device, a user context; identify one or more potentially relevant content items from the remote clipped content data storage based on the received user context and the metadata generated by the computing device and associated with content items in the remote clipped content data storage; and provide, through the network interface, to the second client computing device, at least some of the potentially relevant content items, the provided content items comprising content items received from other client computing devices differing from the second client computing device.

A eleventh example is the computing device of the tenth example, wherein the image recognition comprises optical character recognition.

An twelfth example is the computing device of the tenth example, wherein the text recognition comprises identification of text as one of: a telephone number, an email address, a geographic address or a web address.

A thirteenth example is the computing device of the tenth example, wherein the one or more computer-readable media comprise further executable instructions which, when executed by the one or more processing units, cause the computing device to further: receive an externally sourced plug-in comprising computer-executable instructions for analyzing the uploaded content item to identify specific types of metadata to which the plug-in is directed; execute the externally sourced plug-in as part of the generating the metadata; and associate, within the remote clipped content data storage, the uploaded content item with the specific types of metadata generated by the execution of the externally sourced plug-in to analyze the uploaded content item.

A fourteenth example is the computing device of the tenth example, wherein the uploaded content item was received because it was cut or copied by the user on the first client computing device.

A fifteenth example is the computing device of the tenth example, wherein the computer-executable instructions for identifying the one or more potentially relevant content items comprise computer-executable instructions, which, when executed by the one or more processing units cause the computing device to rank, in order of relevance, the one or more potentially relevant content items.

A sixteenth example is the computing device of the tenth example, wherein the identification of the user with whom the uploaded content item is associated comprises an identification of both the user utilizing the first client computing device and another, different user.

A seventeenth example is a system comprising: a first client computing device comprising one or more computer-readable media comprising computer-executable instructions which, when executed by one or more processing units of the first client computing device, cause the first client computing device to: detect addition of a new content item to a first operating system clipboard through a user-initiated cut or copy command; and upload the new content item; a second client computing device, differing from the first client computing device, the second client computing device comprising one or more computer-readable media comprising computer-executable instructions which, when executed by one or more processing units of the second client computing device, cause the second client computing device to: detect a user action on the second computing device indicative of an entry of content into an application program executing on the second computing device; determine a context of the detected user action; identify one or more potentially relevant content items from the remote clipped content data storage based on the determined context and metadata associated with content items in the remote clipped content data storage; and proactively provide at least some of the potentially relevant content items to be entered into the application program in furtherance of the detected user action; and a server computing device comprising one or more computer-readable media comprising computer-executable instructions which, when executed by one or more processing units of the sever computing device, cause the server computing device to: receive the uploading of the new content item from the first client computing device; generate metadata associated with the new content item by performing at least one of image recognition or text recognition on the new content item; store the new content item into the remote clipped content data storage; associate, within the remote clipped content data storage, the new content item with the generated metadata; receive, from the second client computing device, the determined context; identify the one or more potentially relevant content items from the remote clipped content data storage based on the determined context and the metadata generated by the computing device and associated with content items in the remote clipped content data storage; and provide, to the second client computing device, the at least some of the potentially relevant content items.

A eighteenth example is the system of the seventeenth example, wherein the computer-executable instructions causing the second client computing device to proactively provide at least some of the potentially relevant content items comprise computer-executable instructions, which, when executed by the one or more processing units of the second client computing device cause the second client computing device to generate a user selection mechanism presenting, for selection by the user, at least some of the potentially relevant content items.

A nineteenth example is the system of the eighteenth example, wherein the computer-executable instructions causing the second client computing device to proactively provide at least some of the potentially relevant content items comprise computer-executable instructions, which, when executed by the one or more processing units of the second client computing device cause the second client computing device to place, onto a second operating system clipboard, a user selected one of the potentially relevant content items.

An twentieth example is the system of the seventeenth example, wherein the computer-executable instructions causing the second client computing device to proactively provide at least some of the potentially relevant content items comprise computer-executable instructions, which, when executed by the one or more processing units of the second client computing device cause the second client computing device to proactively enter, directly in response to the detected user action, a single potentially relevant content item into an input mechanism presented by the application program the input mechanism configured to accept a specific type of data, the single potentially relevant content item being an only content item, from among the potentially relevant content items, having the specific type of data that the input mechanism is configured to accept.

As can be seen from the above descriptions, mechanisms for providing data exchange across multiple computing devices through a proactive intelligent clipboard have been presented. In view of the many possible variations of the subject matter described herein, we claim as our invention all such embodiments as may come within the scope of the following claims and equivalents thereto.

We claim:

1. A computing device comprising:
one or more processing units;
a network interface; and
one or more computer-readable media comprising computer-executable instructions which, when executed by the one or more processing units, cause the computing device to:
detect addition of a new content item to an operating system clipboard through a user-initiated cut or copy command;
upload, through the network interface, the new content item to a remote clipped content data storage;
detect a user action on the computing device indicative of an entry of content into an application program executing on the computing device;
determine a context of the detected user action;
identify one or more potentially relevant content items from the remote clipped content data storage based on the determined context and metadata associated with content items in the remote clipped content data storage; and
proactively provide at least some of the potentially relevant content items to be entered into the application program in furtherance of the detected user action.

2. The computing device of claim 1, wherein the computer-executable instructions for proactively providing at least some of the potentially relevant content items comprise computer-executable instructions, which, when executed by the one or more processing units cause the computing device to generate a user selection mechanism presenting, for selection by the user, at least some of the potentially relevant content items.

3. The computing device of claim 2, wherein the computer-executable instructions for proactively providing at least some of the potentially relevant content items comprise computer-executable instructions, which, when executed by the one or more processing units cause the computing device to place, onto the operating system clipboard a user selected one of the potentially relevant content items.

4. The computing device of claim 1, wherein the computer-executable instructions for proactively providing at least some of the potentially relevant content items comprise computer-executable instructions, which, when executed by the one or more processing units cause the computing device to proactively enter, directly in response to the detected user action, a single potentially relevant content item into an input mechanism presented by the application program, the input mechanism configured to accept a specific type of data, the single potentially relevant content item being an only content item, from among the potentially relevant content items, having the specific type of data that the input mechanism is configured to accept.

5. The computing device of claim 1, wherein the potentially relevant content items were clipped from one or more application programs executing on one or more other computing devices differing from the computing device.

6. The computing device of claim 1, wherein the determined context comprises content pasted by the user into the application preceding the detected user action.

7. The computing device of claim 1, wherein the one or more computer-readable media comprise further computer executable instructions, which, when executed by the one or more processing units, cause the computing device to:
proactively clip another content item that was either entered by the user or presented to the user; and
upload, through the network interface, the other content item to the remote clipped content data storage.

8. The computing device of claim 7, wherein the proactive clipping of the other content item is triggered by the other content item being of a predefined type.

9. The computing device of claim 1, wherein the identified one or more potentially relevant content items comprise content items clipped by a different user.

10. A computing device comprising:
one or more processing units;
a network interface; and
one or more computer-readable media comprising computer-executable instructions which, when executed by the one or more processing units, cause the computing device to:
receive, through the network interface, from a first client computing device, an uploaded content item and an identification of a user with whom the uploaded content item is associated;
generate metadata associated with the uploaded content item by performing at least one of image recognition or text recognition on the uploaded content item;
store the uploaded content item into a remote clipped content data storage;
associate, within the remote clipped content data storage, the uploaded content item with the generated metadata and the identified user;
receive, through the network interface, from a second client computing device differing from the first client computing device, a user context;
identify one or more potentially relevant content items from the remote clipped content data storage based on the received user context and the metadata generated by the computing device and associated with content items in the remote clipped content data storage; and
provide, through the network interface, to the second client computing device, at least some of the potentially relevant content items, the provided content items comprising content items received from other client computing devices differing from the second client computing device.

11. The computing device of claim 10, wherein the image recognition comprises optical character recognition.

12. The computing device of claim 10, wherein the text recognition comprises identification of text as one of: a telephone number, an email address, a geographic address or a web address.

13. The computing device of claim 10, wherein the one or more computer-readable media comprise further executable instructions which, when executed by the one or more processing units, cause the computing device to further:
receive an externally sourced plug-in comprising computer-executable instructions for analyzing the uploaded content item to identify specific types of metadata to which the plug-in is directed;
execute the externally sourced plug-in as part of the generating the metadata; and
associate, within the remote clipped content data storage, the uploaded content item with the specific types of metadata generated by the execution of the externally sourced plug-in to analyze the uploaded content item.

14. The computing device of claim 10, wherein the uploaded content item was received because it was cut or copied by the user on the first client computing device.

15. The computing device of claim 10, wherein the computer-executable instructions for identifying the one or more potentially relevant content items comprise computer-executable instructions, which, when executed by the one or more processing units cause the computing device to rank, in order of relevance, the one or more potentially relevant content items.

16. The computing device of claim 10, wherein the identification of the user with whom the uploaded content item is associated comprises an identification of both the user utilizing the first client computing device and another, different user.

17. A system comprising:
a first client computing device comprising one or more computer-readable media comprising computer-executable instructions which, when executed by one or more processing units of the first client computing device, cause the first client computing device to:
detect addition of a new content item to a first operating system clipboard through a user-initiated cut or copy command; and
upload the new content item;
a second client computing device, differing from the first client computing device, the second client computing device comprising one or more computer-readable media comprising computer-executable instructions which, when executed by one or more processing units of the second client computing device, cause the second client computing device to:
detect a user action on the second computing device indicative of an entry of content into an application program executing on the second computing device;
determine a context of the detected user action;
identify one or more potentially relevant content items from the remote clipped content data storage based on the determined context and metadata associated with content items in the remote clipped content data storage; and
proactively provide at least some of the potentially relevant content items to be entered into the application program in furtherance of the detected user action; and
a server computing device comprising one or more computer-readable media comprising computer-executable instructions which, when executed by one or more processing units of the sever computing device, cause the server computing device to:
receive the uploading of the new content item from the first client computing device;
generate metadata associated with the new content item by performing at least one of image recognition or text recognition on the new content item;
store the new content item into the remote clipped content data storage;
associate, within the remote clipped content data storage, the new content item with the generated metadata;
receive, from the second client computing device, the determined context;
identify the one or more potentially relevant content items from the remote clipped content data storage based on the determined context and the metadata generated by the computing device and associated with content items in the remote clipped content data storage; and
provide, to the second client computing device, the at least some of the potentially relevant content items.

18. The system of claim 17, wherein the computer-executable instructions causing the second client computing device to proactively provide at least some of the potentially relevant content items comprise computer-executable instructions, which, when executed by the one or more processing units of the second client computing device cause the second client computing device to generate a user selection mechanism presenting, for selection by the user, at least some of the potentially relevant content items.

19. The system of claim 18, wherein the computer-executable instructions causing the second client computing device to proactively provide at least some of the potentially relevant content items comprise computer-executable instructions, which, when executed by the one or more processing units of the second client computing device cause the second client computing device to place, onto a second operating system clipboard, a user selected one of the potentially relevant content items.

20. The system of claim 17, wherein the computer-executable instructions causing the second client computing device to proactively provide at least some of the potentially relevant content items comprise computer-executable instructions, which, when executed by the one or more processing units of the second client computing device cause the second client computing device to proactively enter, directly in response to the detected user action, a single potentially relevant content item into an input mechanism presented by the application program the input mechanism configured to accept a specific type of data, the single potentially relevant content item being an only content item, from among the potentially relevant content items, having the specific type of data that the input mechanism is configured to accept.
